(19) United States
(12) Patent Application Publication
(10) Pub. No.: US 2013/0221873 A1
(43) Pub. Date: Aug. 29, 2013

(54) LED COLOR CHANNELS INCLUDING PHOSPHOR-BASED LEDS FOR HIGH LUMINOUS EFFICACY LIGHT SOURCE

(71) Applicant: Lumenetix, Inc., (US)

(72) Inventor: Matthew D. Weaver, Aptos, CA (US)

(73) Assignee: Lumenetix, Inc., Scotts Valley, CA (US)

(21) Appl. No.: 13/770,595

(22) Filed: Feb. 19, 2013

Related U.S. Application Data
(60) Provisional application No. 61/600,552, filed on Feb. 17, 2012.

(51) Int. Cl. H05B 33/08; H05B 33/10

(52) U.S. Cl. CPC H05B 33/0857; H05B 33/10
USPC 315/294; 362/84; 445/23

(57) ABSTRACT

A light source apparatus is disclosed. The light source includes an array of light emitting diodes (LEDs) including at least three color channels, the at least three color channels includes: a yellow-greenish channel including a YAG:Ce phosphor emitter pumped by a royal blue InGaN LED; a red channel including a second LED, the second LED being either phosphor-based LED or AlInGaP LED; and a blue green channel including a third LED wherein the third LED is a royal blue InGaN LED. The light source further includes a mixing barrel around the array of LEDs for mixing light generated from the three color channels to simulate a black body radiator at different correlated color temperatures. Each of the at least three color channels includes one or more LEDs emitting the same color.

### CROSS-REFERENCES TO RELATED APPLICATIONS

This application claims the benefit of U.S. Provisional Patent Application Ser. No. 61/600,552 filed Feb. 17, 2012, and which is incorporated herein by reference in its entirety. This application is related to U.S. application Ser. No. 13/367,187, entitled, “SYSTEM AND METHOD FOR MIXING LIGHT EMITTED FROM AN ARRAY HAVING DIFFERENT COLOR LIGHT EMITTING DIODES”, filed Feb. 6, 2012, which is s incorporated herein by reference in its entirety.

### BACKGROUND

Light emitting diodes (LEDs) that emit at different wavelength bands can be used together to provide light that has a desired color temperature, for example, simulating a particular light source such as sun light, incandescent light bulbs, or fluorescent light. Color mixing LEDs is a difficult task because of the limited color spectrum available for each type of LED. Some LEDs shine brighter, having higher lumens per radiometric watt, while other LEDs are more efficient, having higher radiometric watts per electric watt. Hence, LED light sources previously have been limited because of the difficulty of finding the right set of LED color sources/channels that matches the desired color spectrum, the desired luminous efficacy, and the desired efficiency.

### BRIEF DESCRIPTION OF THE DRAWINGS

Examples of an LED-based lighting system are illustrated in the figures. The examples and figures are illustrative rather than limiting.

FIG. 1 shows a perspective view illustrating a sample apparatus including a high density LED array.

FIG. 2 shows a cross sectional view of one LED within the array and components beneath the LED.

FIG. 3 illustrates an example of a tunable color space by the combination of three LED source channels.

FIG. 4A illustrates emission spectra of MSi₂O₂N₂:Eu²⁺ phosphors containing one or two alkaline earth cations.

FIG. 4B illustrates emission spectra of Ba₂Si₂O₂N₂:Eu²⁺ and Ba₂SiO₄:Eu²⁺ phosphors.

FIG. 4C illustrates emission spectra of Sr_{0.98-x}BaₓSi₂O₂N₂:Eu²⁺ phosphor.

FIG. 5 shows a perspective view illustrating an example mixing barrel in an LED-based lamp.

FIG. 6 is a flow diagram illustrating an example process of mixing light from an LED array using a mixing barrel.

### DETAILED DESCRIPTION

LED color channels for high luminous efficacy light sources are disclosed. Particularly, a light emitting apparatus is described using an array of LEDs that emit light having different colors. The array of LEDs can include a plurality of color channels. Each color channel can be one or more LEDs of the same type emitting substantially similar wavelength range in the color spectrum. The array of LEDs can include three or four LED color channels. A yellow greenish channel can be configured by different levels of Yittrium-Aluminum Garnet, Cerium 3+ doped, Y₃Al₅O₁₂ (YAG-Ce) phosphor pumped a blue or royal blue InGaN LED. A blue green channel can be configured by different levels of Si₂O₂N₂ based phosphors, such as BaₓSi₂O₂N₂:Eu²⁺ phosphors, pumped by a blue or royal blue InGaN LED. The blue green channel can be sub-divided into two sub-channels, one towards the peak emission wavelength of the phosphor and one towards the peak emission wavelength of the royal blue InGaN LED. A red channel can be configured by a AlInGaP LED or a red emitting phosphor pumped by InGaN a royal blue LED.

The color channel configurations have been discovered to approximate black body radiator closely. The color channel configurations have also been discovered to have high luminous efficacy together with high radiometric efficiency. The color channel configurations further has the advantage of having simplified color tuning control, where the emission color of the combined color channels can traverse along low to mid-level CCT by driving the red channel and the yellow greenish channel full on and driving the blue-green channel from low to full max; and along mid to high level CCT by driving equal level of the red channel and the yellow greenish channel from max to low with the blue-green channel driven full on.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

A light emitting diode (LED) emits light in a narrow band of wavelengths. Two or more LEDs emitting in different wavelength bands can be used together in a lamp to generate composite light having a desired color temperature. When light from multiple LEDs are used together, the light from the LEDs should be mixed so that the light appears uniform, rather than as localized spots of different color light. Additionally, when multiple LEDs are used in an LED array, the array has a large area and does not provide a narrow output beam angle. Described below is a mixing barrel that can be used to homogenize the light emitted from an LED array and to effectively provide a small source with a narrow output beam angle.

### High Density LED Array

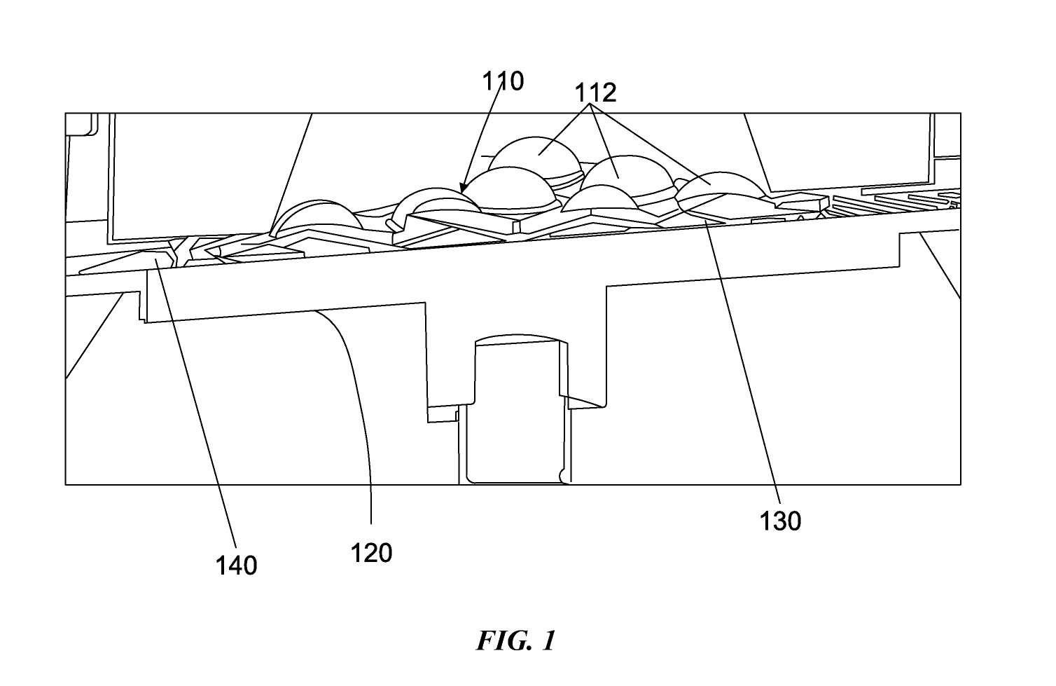

A lighting apparatus having a high density LED array using high volume, low cost, reliable LEDs is described. The apparatus may utilize a mixing barrel as discussed in the next sections of the disclosure. FIG. 1 illustrates a sample apparatus including a high density LED array. The apparatus 100 includes a planar array 110 of LEDs 112. In one embodiment, the LEDs 112 are high-power LED packages such as Lumiled Luxeon Rebel or CREE XRG. These LED packages are highly-tested, high-volume, proven LED packages. The LEDs 112 are mechanically mounted on top of a heat conductor 120. For each of LEDs 112, there is a thermal pad 130 between the LED and the heat conductor 120. The thermal pad may contain copper. In one embodiment, there is an individual thermal pad beneath each LED. In another embodiment, one or more LEDs may share one thermal pad. The LED is thermally coupled to the thermal pad 130 and then the thermal pad 130 is thermally coupled to the heat conductor 120. In one embodiment, the LED is thermally coupled by means of solder or oriented carbon fiber film. The heat conductor may be a coin-shaped article made of copper. Thus, most heat generated by the LEDs 112 is transferred to the heat conductor 120 with very little heat resistance. The heat conductor may connect to another heat sink to further dissipate the heat. A flexible printed circuit 140 is designed to electrically connect to all the LEDs 112 of the array 110 via their electrical contacts. A flexible printed circuit is a patterned arrangement of printed wiring utilizing flexible base material with or without flexible cover layers. The flexible printed circuit uses flexible base material so that mechanical stress due to the thermal expansion and contraction is minimized and cracking is prevented. The apparatus has superior thermal dissipation ability because the heat generated by the LEDs 112 flows through a thermal channel of the thermal pad 130 and the heat conductor 120 with minimum thermal resistance. Therefore, it is possible to arrange the LEDs 112 in close proximity while not overheating the LEDs. The LEDs 112 may be arranged with an average spacing between the neighboring LEDs of less than 4 millimeters, preferably less than 3 millimeters. As shown in FIG. 1, the LED array 110 forms a planar Lambertian disc with a diameter of from about 10 millimeters to about 18 millimeters. The light intensity from the planar Lambertian disc to an observer is the same regardless of the observer's angle of view. The design is a lighting solution with low cost, high efficacy and reliability. The product life may exceed 50,000 hours.

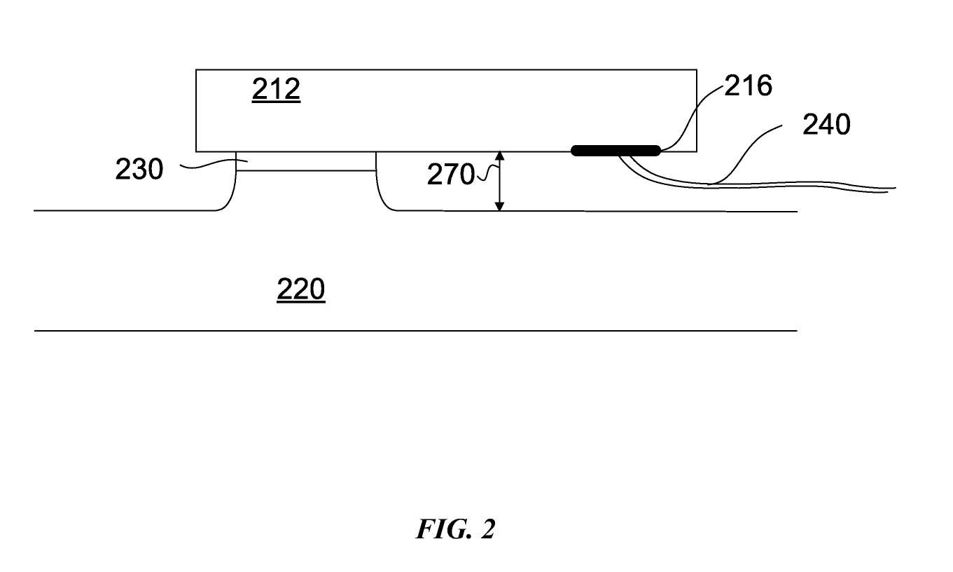

FIG. 2 shows a cross sectional view of one LED within the array and the components beneath the LED. The LED 212 is mounted on a heat conductor 220 via a thermal pad 230. The LED 212 may be a LED package including a ceramic base. The thermal couplings between the LED 212 and thermal pad 230, and between the thermal pad 230 and heat conductor 220, have minimum thermal resistance. A major portion of the heat generated by the LED 212 is transferred to the heat conductor 220 through the highly efficient thermal channel. In one embodiment, all LEDs within the LED array are mounted on the same heat conductor via thermal pads. The heat conductor may be mounted on another heat sink to further dissipate the heat. In one embodiment, the heat sink may be mounted to the heat conductor by a screw on the bottom. In another embodiment, the heat sink may be mounted by screwing the heat sink onto two ears of the heat conductor. In yet another embodiment, the heat sink may be mounted by spring steel clips that are analogous to heat sink block clips for computer CPU chips. The heat sink applies constant spring pressure between the heat conductor and head sink independent of time, temperature and cycling. The LED 212 has one or more electrical contacts 216. In one embodiment, the electric contacts 216 are wire bonds contacts. In another embodiment, the electric contacts 216 are polyamide holt-melt matrix film (Nickel fiber) that can be applied by pressure and heat. The film forms an electrical contact between the LED and contacts pads of a flex printed circuit. The flexible printed circuit 240 is electrically connected to the electrical contacts 216 to supply and fine-tune electric power for the LED 212. Light characteristics such as color rendering index (CRI) and correlated color temperature (CCT) can be adjusted by tuning the intensities of the LEDs within the array. The flexible base material in the flexible printed circuit 240 prevents cracking of ceramic bases of the LED packages due to the thermal expansion and contraction. As shown in FIG. 8, there is spacing 270 between the LED 212 and the heat conductor 220. In one embodiment, epoxy resin can be capillary backfilled in the spacing 270. As a result, the LED electrical contacts 216 is further isolated for high-voltage tracking with the thermal pad 230. The epoxy resin may be precision backfilled by a jetting applier or a drop applier.

An objective of the LED arrays is to achieve a high luminous efficacy using a minimum number of channels of source spectra to construct high-quality light, where the combined channels are tunable across preferably 2500-6500 CCT with high color rendition, preferably from 90-98 CRI. The color rendition requirement ensures that illumination quality is indistinguishable from a black body radiator source at the same CCT.

The LED array may contain LEDs with different emitting colors to achieve better color characteristics and enable color and/or CCT tuning. In one embodiment, the LED array can include three channels. A LED array with three channels is ideal because all color points are deterministic from a finite combination of sources to obtain a color point.

### Three Channel LED Array

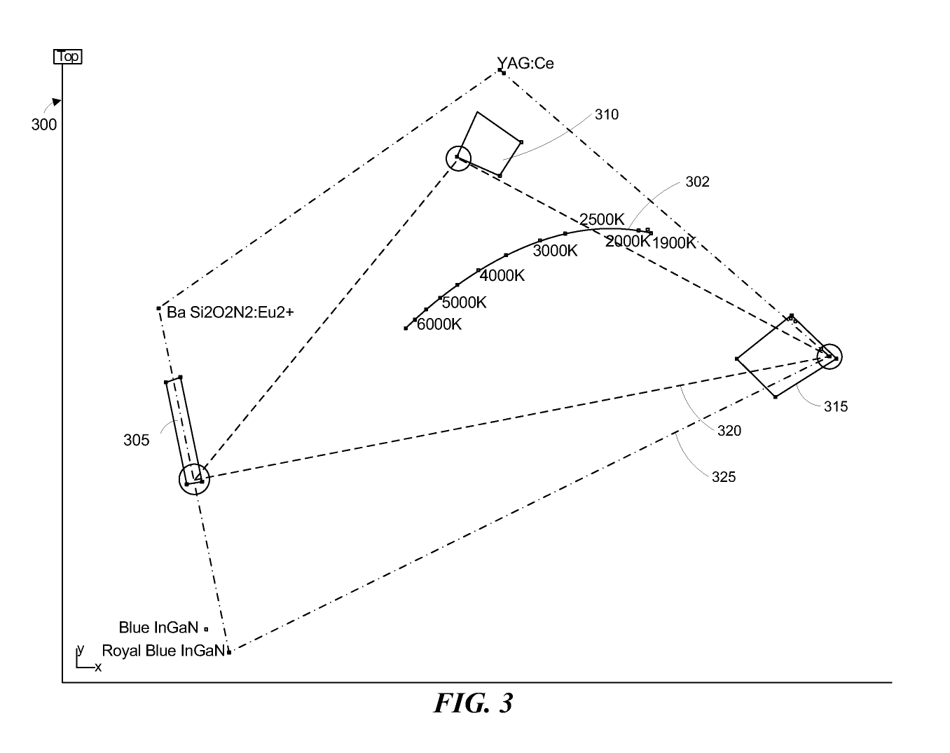

FIG. 3 illustrates an example of a tunable color space 300 by the combination of three LED source channels. The color spaces of each source channel is compared against the Planckian Locus 302. In this example, the LED array includes one or more red-emitting LEDs (i.e., red LED channel), one or more blue-green-emitting LEDs (i.e., blue-green LED channel), and one or more yellow-greenish-emitting LEDs (i.e., yellow-greenish LED channel). The yellow-greenish-emitting LED includes a blue LED die and a YAG:Ce phosphor. The amount of YAG:Ce phosphor can be increased such that the light emitted by the yellow greenish LED turns from white to yellow greenish. In one embodiment, the extra YAG:Ce phosphor may be applied in a remote phosphor dome disposed over the existing white-emitting LED to form a yellow-emitting LED. The remote phosphor dome may be a hemispherical cap disposed over the LED encapsulation. In another embodiment, the extra YAG:Ce phosphor may be disposed directly within the LED packages.

The blue green LED channel serves to fill a spectral hole around 490 nm wavelength critical for a high-CRI illumination. As a specific example, the blue green LED channel can be one or more blue-pumped phosphor emitting LED. Ba-Si₂O₂N₂:Eu2++ (0.094 to 0.98 Ba, balance Eu2++), is a preferred phosphor discovered to fill the spectral hole when combined with a blue LED. Other potential replacement is also contemplated, including quantum dots at a sufficiently stable temperature.

This specific example of blue green LED channel is advantageous because phosphor conversion using 490 nm peak phosphor+royal blue or blue LED yields substantially greater lumens than a InGaN device alone in the 490 nm range. The broadness of spectrum of this specific example of blue green LED source channel is also greater than other alternatives, thus yielding higher CRI mixes. This blue green LED channel has greater color tuning pull per electrical watt when compared to InGaN blue or royal blue alone, resulting in higher lumens across the CCT range and flatter lumens output curve across the CCT range.

During operation, the LED array can generate warm colors having a low CCT value by driving the yellow greenish LED channel and the red LED channel full on. The LED array can generate cooler colors having a high CCT value by throttling the blue-green LED channel and maintaining a substantially constant radio of the yellow-greenish LED channel and the red LED channel. The LED array can generate mid-value CCT near 4100K, such as between 3800K-4400K or between 3900K-4300K, by turning all three LED color channels full on. For color ranges beyond mid-CCT, the blue-green LED channel is driven on max state, and the yellow greenish LED channel and the red channel are driven down substantially equally.

The blue greenish LED channel can be in a color zone 305 defined by the spectra of InGaN royal blue LEDs plus the emission spectra of: 490 nm peak Ba(0.94-0.98)−Si2O2N2:Eu2+(0.06-0.02) luminous phosphor excited by a portion of the InGaN royal blue emission. “Royal blue” as used here is an InGaN LED in the 440-460 nm range emission peak. In this specific example, roughly 50-75% of total lumens is from the phosphor emission. The phosphor in this example yields around 210+ lumens/radiometric watt. The color zone 305 can be defined by a tetragon with corners at the nominal color coordinates (CIE 1931 xy): (0.127462, 0.183467), (0.108023,0.279327), (0.094522,0.274454), and (0.113662,0.181167).

In an alternative embodiment, the blue green LED channel can include one or more fixed ratio InGaN Blue LED at emission peak wavelength range of 460-490 nm. Small amount of additional blue InGaN has the potential of slightly improving the CRI, but may be near same luminous efficacy of the specific example above due to inferior radiometric efficiency of the blue InGaN LED (higher lumens per radiometric watt, but inferior radiometric watts/electrical watt).

Alternatively, the blue green LED channel can be sub-divided into 2 sub-channels (4 channels for complete system). One channel can be one or more of InGaN blue LEDs and another channel can be one or more of InGaN royal blue LED doped with Ba(0.94-0.98)−Si2O2N2:Eu2+(0.06-0.02). The combination the two channels can yield color point in same zone as the single blue green LED channel described in the specific example above.

Another alternative includes replacing the single blue green LED channel with one or more long wavelength InGaN Blue LEDs with 490 nm peak wavelength range combined with one or more InGaN blue and/or royal blue LEDs. A potential limitation is that longer wavelength InGaN devices have considerably lower radiometric efficiency (as compared to royal blue InGaN LEDs in the “sweet spot” for the efficiency. The long wavelength InGaN devices are less optimized and the resultant luminous output may suffer.

The yellow-greenish LED channel can be in a color zone 310 defined by the spectra of YAG:Ce (Yittrium-Aluminum Garnet, Cerium 3+ doped, Y₃Al₅O₁₂) phosphor combined with a InGaN royal blue LED. In this color zone 310, the YAG phosphor spectrum yields over 400 Lumens/radiometric watt. 80-90% of total lumens of the yellow-greenish LED channel are derived from the YAG luminous phosphor. The color zone 310 can be defined by a tetragon with corner at the nominal color coordinates: (0.360638,0.480911), (0.399681,0.464340), (0.419245,0.494098), and (0.379575,0.521592).

The red LED channel can be in a color zone 315 defined by the spectra of AlInGaP Red or else InGaN royal blue exciting a high efficiency luminous red phosphor—family of red nitride phosphors or some novel high-efficiency narrow emission band red luminous phosphors (90-95% of total lumens derived from red luminous phosphor. The color zone 315 can be defined by a tetragon with corners at the nominal color coordinates: (0.707386,0.295750), (0.666533,0.335849), (0.616676, 0.295879), and (0.651304, 0.261264).

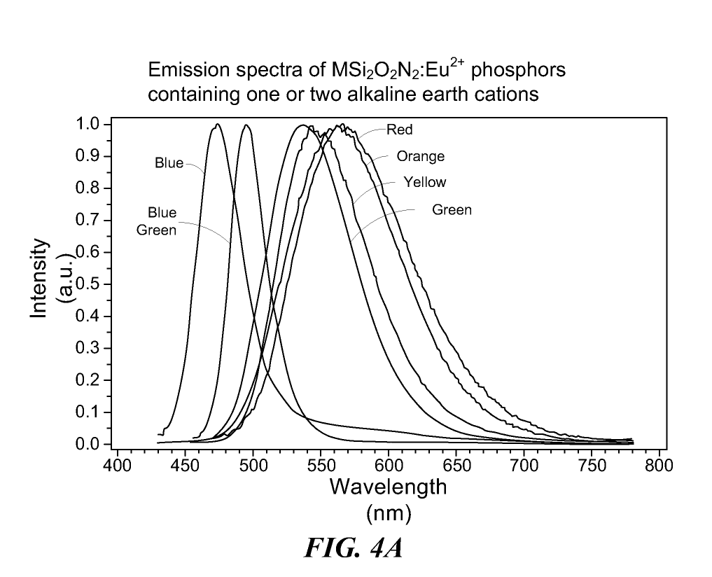

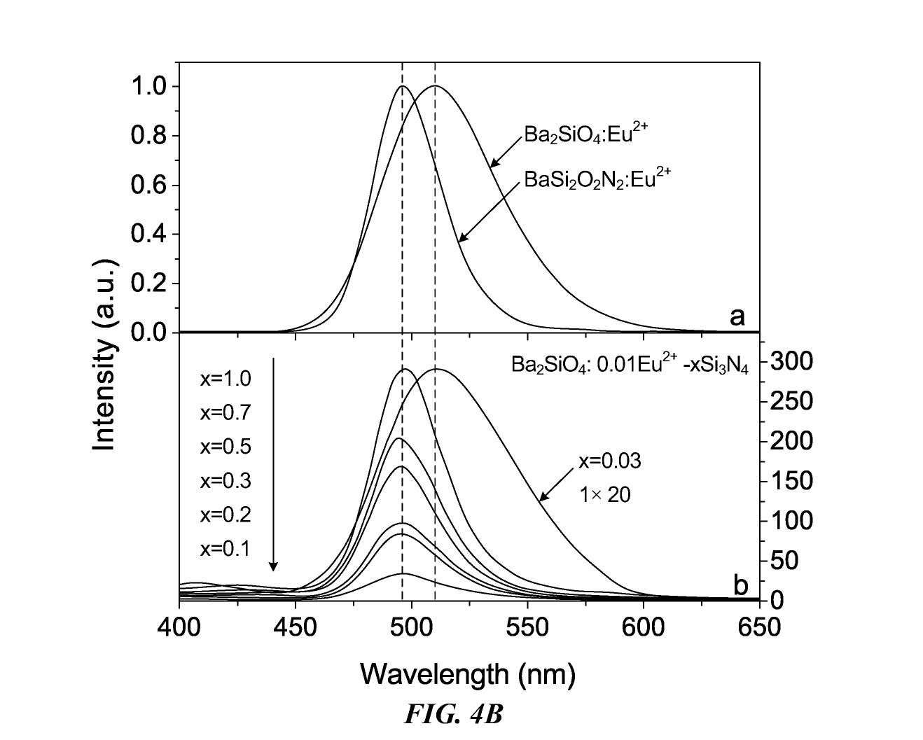

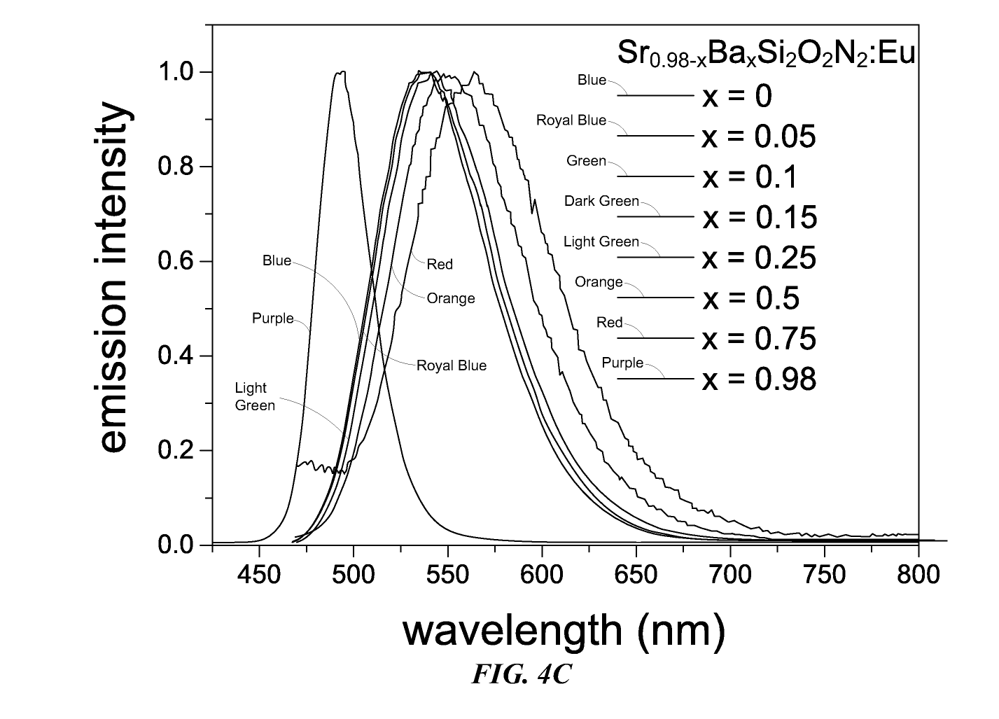

A tunable color space 320 can be achieved by the specific example described above by the LED color channels in the color zones 305, 310 and 315. The tunable color space 320 allows for easy emulation of the black body radiators along the Plankian locus. A configurable color space 325 can be achieved by: changing the phosphor emission percentage of the YAG:Ce combined with the InGaN royal blue LED pump to move the color zone 310 towards the color wavelengths of the YAG:Ce emission; and by changing the phosphor emission percentage of the Ba-Si₂O₂N₂:Eu2++(0.094 to 0.98 Ba, balance Eu2++) phosphor combined with the InGaN royal blue LED pump. FIGS. 4A-4C further illustrate ways to configure the peak wavelength of the blue-green phosphors to expand the configurable color space 325 by moving the color zone 305. The configurable color space 325 can include four channel LED array systems as described below.

### Four Channel LED Array

In another embodiment, the LED array includes one or more red-emitting LEDs, one or more blue-emitting LEDs, one or more yellow-emitting LEDs, and one or more cyan-emitting LEDs. The cyan-emitting LED may have a blue LED die and a Ba:Si Oxynitride Eu-doped phosphor. In one embodiment, the Ba:Si Oxynitride Eu-doped phosphor may also be disposed via a remote phosphor dome as discussed above. In another embodiment, the Ba:Si Oxynitride Eu-doped phosphor may be disposed directly within the LED packages. The LED array with mixing color LEDs may achieve a wide range of correlated color temperatures (CCTs), such as from 1800 to 7000 Kelvin, while maintaining a high color rendering index (CRI) of more than 90, or even 95. The solution enables color tuning by changing the numbers of different color LEDs. Furthermore, the solution eliminates the need of white LED binning, since the color shifting is compensated by the mixing of the different color LEDs. By controlling the throttling of different color LEDs, a high CRI spectrum is rebuilt by utilizing high production volume, low cost, reliable LEDs.

Mixing Barrel with Air Cavity

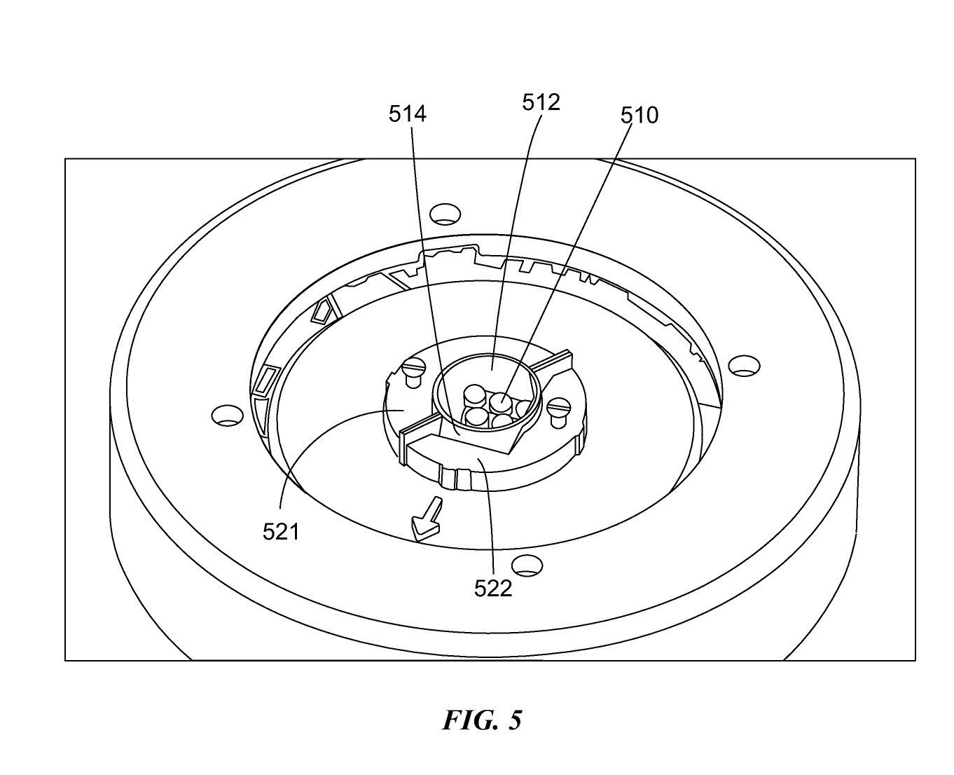

FIG. 5 shows a perspective view illustrating an example mixing barrel in an LED-based lamp. The LED-based lamp includes an LED array 510 that has multiple LEDs, and the LEDs emit light at two or more different wavelength bands.

In one embodiment, the mixing barrel has two sections 512, 514 that are clamped together by holders 521, 522. In one embodiment, the holders 521, 522 suspend the mixing barrel sections 512, 514 slightly above the LED array 510 so that there is a clearance space between the mixing barrel and the LED array 510 to prevent pressure from being placed on the array.

In one embodiment, each of the sections 512, 514 of the mixing barrel is made from formable sheet metal, such as aluminum. The lower edge of the sheet metal sections that is closest to the LED array is crimped to form a shape that conforms, or nearly conforms, to the shape of the LEDs in the array, while the upper edge of the sheet metal sections farthest from the array is smooth. Note that while the terms ‘lower edge’ and ‘upper edge’ are used to describe the mixing barrel, the mixing barrel can be oriented in any direction. Because the lower edge of the barrel is crimped to follow the small features that correspond to the shape of the LEDs, the metal of the mixing barrel should be fairly thin. By shaping the lower edge of the mixing barrel to match the shape of the LEDs, the amount of light emitted by the LEDs that is captured by the mixing barrel can be maximized. Additionally, the total length of the crimped lower edge and the smooth upper edge are substantially equal for ease of manufacturing the mixing barrel.

Once captured, the light from the LEDs reflects multiple times against the inner surface of the mixing barrel as it is funneled towards the upper edge of the mixing barrel. In one embodiment, the inner surface of the mixing barrel is coated with a highly reflective specular coating, such as a silver coating. By using a highly reflective specular coating, the energy lost each time light from the LEDs reflects from the surface of the mixing barrel is minimized. Further, a transparent coating, such as silicon dioxide, can be placed over the specular coating as a protective layer.

In one embodiment, instead of coating the inner surface of the mixing barrel with a highly reflective coating, a highly reflective diffusive substrate can be used, such as White97 film or DuPont™ DLR80 from WhiteOptics of Newark, Del. or a Teflon™-basedsolid, such as Gore DRP from W. L. Gore & Associates, Inc. of Newark, Del. By using a highly reflective diffuse material, light impinging on the surface is reflected at multiple angles, resulting in further mixing of the different colors of light from the LEDs.

In another embodiment, the mixing barrel can be formed using a plastic injection-molded mixing barrel that is electroless nickel plated to form a metallic base coat. The base coat is then coated with a highly reflective specular coating, such as silver or aluminum, and optionally coated with a high reflectivity dielectric stack coating.

In yet another embodiment, the mixing barrel can be made from press-molded glass that is coated with a highly reflective specular coating.

With either the press-molded glass or plastic injection-molded mixing barrel, the diffusive reflective materials specified above can be conformally applied to the surface of mixing barrel. Alternatively, there are diffuse white reflector coatings that can be applied to the mixing barrel surface that have nearly the same performance but are more delicate. For example, barium sulfate (BaSO₄) can be applied as a powder-spray to the surface by using a carrier solution such as polyvinyl alcohol (PVA). High reflectivity white diffuse paints can also be used that typically contain a high percentage of BaSO₄.

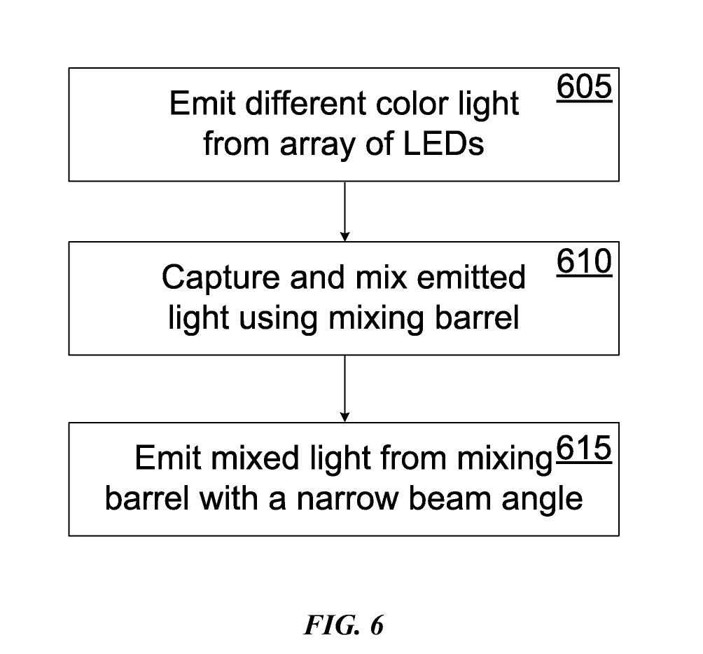

FIG. 6 is a flow diagram illustrating an example process of mixing light from an LED array using a mixing barrel. At block 605, the system emits light from an array of LEDs, and the LEDs emit light at different wavelength bands.

Then at block 610, the light emitted from the LED array is captured by the mixing barrel. If the mixing barrel has an air cavity, the captured light is mixed as a result of multiple reflections of the light from the inner reflective surface of the mixing barrel. If the mixing barrel has a refractive block, that light is either totally internally reflected within the block or exits the block to be reflected by the inner reflective surface of the mixing barrel and re-enters the refractive block. The light continues to be either totally internally reflected or reflected by the mixing barrel surface until at block 615, the funnel shape of the mixing barrel causes the light to be emitted from the top of the mixing barrel with a narrow beam angle. In one embodiment, the top of the mixing barrel is covered with a diffuser to further diffuse the light emitted from the mixing barrel.

The light emitted from the mixing barrel, with or without the diffuser, is nearly Lambertian. However, because the exit window of the mixing barrel is relatively small, it acts as a smaller source having a lower etendue than the LED array would have alone. As a result, secondary optics used in conjunction with the mixing barrel can generate narrower beam angles than the LED array alone.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method of manufacture of a light source comprising:
configuring an array of light emitting diodes (LEDs) including at least three color channels each emitting the same color by:
selecting a yellow-greenish channel including a YAG:Ce phosphor emitter pumped by a first LED;
selecting a red channel including a second LED;
selecting a blue green channel including a phosphor emitter pumped by a third LED;
providing a mixing barrel for mixing light generated from the three color channels to simulate a black body radiator at different correlated color temperatures; and
attaching the array of LEDs within the mixing barrel.

2. The method of claim 1, further comprising disposing a hemispherical cap over at least a portion of the YAG:Ce phosphor emitter.

3. The method of claim 1, further comprising disposing a hemispherical cap over at least a portion of the phosphor emitter of the blue green channel.

4. The method of claim 1, wherein selecting the yellow greenish channel includes selecting the yellow greenish channel emitting light within a color zone defined by a tetragon in the International Commission on Illumination (CIE) chromaticity diagram having coordinates of: (0.360638,0.480911), (0.399681,0.464340), (0.419245,0.494098), and (0.379575,0.521592).

5. The method of claim 1, wherein selecting the blue green channel includes selecting the blue green channel emitting light within a color zone defined by a tetragon in. the International Commission on Illumination (CIE) chromaticity diagram having coordinates of: (0.127462, 0.183467), (0.108023,0.279327), (0.094522,0.274454), and (0.113662,0.181167).

6. A method of operating of a color tunable light source with light emitting diodes (LEDs) comprising:
color tuning the color tunable light source to a warm color with a low correlated color temperature (CCT) level by driving a red channel and a yellow greenish channel full on, the red channel and the yellow greenish channel each with one or more LEDs emitting the same color;
color tuning the color tunable light source to a cool color with a high CCT level by driving a blue green channel full on, the blue green channel with one or more LEDs emitting the same color; and
color tuning the color tunable light source to a mid CCT level between the high CCT level and the low CCT level by driving the blue green channel, the red channel, and the yellow greenish channel full on.

7. The method of claim 6, wherein the high CCT level is 6500K.

8. The method of claim 6, wherein the low CCT level is 2500K.

9. The method of claim 6, wherein the mid CCT level is 4100K.

10. The method of claim 6, further comprising color tuning from the low CCT level to the mid CCT level by driving the blue channel from low to full on.

11. The method of claim 6, further comprising color tuning from the mid CCT level to the high CCT level by driving the red channel and the yellow greenish from full on to low while maintaining a constant ratio of the red channel to the yellow greenish channel.

12. A light source apparatus comprising:
an array of light emitting diodes (LEDs) including at least three color channels, the at least three color channels includes:
a yellow-greenish channel including a YAG:Ce phosphor emitter pumped by a first LED, wherein the first LED is a royal blue InGaN LED;
a red channel including a second LED; and
a blue green channel including a third LED wherein the third LED is a royal blue InGaN LED; and
a mixing barrel around the array of LEDs for mixing light generated from the three color channels to simulate a black body radiator at different correlated color temperatures;
wherein each of the at least three color channels includes one or more LEDs emitting the same color.

13. The light source apparatus of claim 12, wherein the blue green channel includes a phosphor emitter pumped by the third LED, the phosphor emitter being a Ba:Si Oxynitride Eu-doped phosphor.

14. The light source apparatus of claim 12, wherein the second LED is an AlInGaP red LED.

15. The light source apparatus of claim 12, wherein the second LED is a InGaN royal blue LED pumping a red luminous phosphor with 90% to 95% of total lumens from the second LED and the red luminous phosphor derived from the red luminous phosphor.

16. The light source apparatus of claim 12, wherein the second LED is a InGaN royal blue LED pumping a red nitride phosphor.

17. The light source apparatus of claim 12, wherein the YAG:Ce phosphor is a Yittrium Aluminum Garnet, Cerium 3+ doped, Y₃Al₅O₁₂.

18. The light source apparatus of claim 12, wherein the phosphor emitter of the blue green channel has the emission spectra peak of 490 nm wavelength.

19. The light source apparatus of claim 12, wherein the blue green channel includes a phosphor emitter pumped by the third LED, the phosphor emitter having peak emission at 490 nm wavelength.

20. The light source apparatus of claim 12, wherein the blue green channel further including a fixed ratio blue InGaN LED in peak emission wavelength range of 460 nm to 490 nm.

21. The light source apparatus of claim 12, wherein the blue green channel includes two sub-channels including a blue InGaN channel and a InGaN royal blue channel doped with Ba:Si₂O₂N₂:Eu2+.

22. The light source apparatus of claim 12, wherein the blue green channel includes a long wavelength InGaN blue LED in peak emission range of 490 nm wavelength.
